(19) United States
(12) Patent Application Publication
(10) Pub. No.: US 2007/0165555 A1
(43) Pub. Date: Jul. 19, 2007

(54) Wireless control systems for digital household appliance

(75) Inventors: Guoshun Deng, Guangdong Province (CN); Xiaohua Cheng, Guangdong Province (CN); Feng Xiang, Guangdong Province (CN); Guanlin Kang, Guangdong Province (CN)

Correspondence Address: DLA PIPER US LLP;ATTN: PATENT GROUP, 1200 NINETEENTH STREET, NW, WASHINGTON, DC, 20036, US

(73) Assignee: Netac Technology Co., Ltd., Shenzhen, Guangdong Province (CN)

(21) Appl. No.: 10/598,422

(22) PCT Filed: Feb. 28, 2005
(86) PCT No.: PCT/CN05/00244

§ 371 Date: Aug. 29, 2006

(30) Foreign Application Priority Data
Feb. 29, 2004 (CN) 200410015523.X

(51) Int. Cl. H04B 7/185

(52) U.S. Cl. 370/318

(57) ABSTRACT

The invention discloses a system for controlling household digital equipment based on wireless. The system comprises a remote device and receiving devices. The remote device sends controlling commands in wireless mode and provides at least two kinds of wireless communication modes. The receiving devices can communicate in the said wireless communication mode, can receive the controlling commands, which are sent by the remote device and can make the household digital equipment perform the controlling commands. The remote device selects the corresponding wireless communication mode according to the controlling commands and communicates with the receiving devices by the selected wireless communication mode.

An existing remote controller typically comprises a key unit, an encoding unit, a radio transmitter unit and a power unit. However, a remote controller is designed to execute some dedicate functions in respect of relevant device. For example, a conventional TV remote controller should implement functions like channel-selection, auto-search, timing-shutdown, listen-only mode, brightness-adjustment, chrominance-adjustment, and volume-adjustment, etc. If a plurality of devices should be controlled, multiple remote controllers are needed. An universal remote controller was developed to operate as a control center in a digital household network so that various devices can be controlled through a wireless communication protocol. Each device in the digital household network includes a radio unit which always stays at a standby state, regardless of transmission of data, so as to determine whether a data packet was sent from other station site according to strength variations of signals in a monitoring channel (in a physical channel, data is transmitted by a carrier signal). Thus, the radio unit will continuously consume power even though nothing is transmitted. Therefore, it is desirable to reduce power consumption of digital household appliance.

### SUMMARY OF INVENTION

Accordingly, the object of the present invention is to provide a wireless control system for digital household appliance with lower power consumption.

The above object is achieved by providing a wireless control system for digital household appliance including at least one device, comprising: a remote controller operationable at least two wireless communication modes for wirelessly transmitting control commands; a receiver or a household device for receiving or executing the control commands transmitted by the remote controller, and wherein the remote controller selects one wireless communication mode from the at least two wireless communication modes according to the control commands to wirelessly communicate with said device or said receiver.

The remote controller may comprise a power unit; a input unit; a radio unit for providing at least two wireless communication modes; and a control unit for selecting one of the at least two wireless communication modes, wherein the control unit selects one wireless communication mode from the at least two wireless communication modes according to control commands selected by a user and transmits the control commands to the devices so as to control operations of the devices.

Compared with the conventional art, the wireless control system for digital household appliance according to the invention may select and switch wireless communication modes based on control commands to be executed so as to avoid any waster of wireless communication resource and save power.

### BRIEF DESCRIPTION OF DRAWINGS

FIG. 1 depicts a digital household network according to the invention;

FIG. 2 illustrates a block diagram of a remote controller for a wireless control system for digital household appliance according to the invention;

FIG. 3 is a block diagram of the control unit of a remote controller according to the wireless control system of the present invention;

FIG. 4 is a block diagram of the receiver according to the invention;

FIG. 5 is a block diagram of a radio unit having lower power-consumption of a remote controller according to the invention;

FIG. 6 is a block diagram of a radio unit having lower power-consumption of a receiver according to the invention;

FIG. 7 schematically illustrates a structure of a wireless local network in an Ad-doc mode;

FIG. 8 schematically illustrates a structure of a wireless local network with access points in an Infrastructure mode;

FIG. 9 is a flowchart showing that the digital household appliance is wirelessly controlled according to the invention; and

FIG. 10 is a flowchart showing that a receiver according to the present invention works.

### EMBODIMENTS OF INVENTION

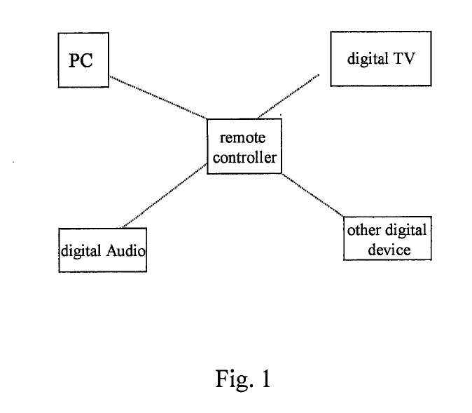

A wireless control system for digital household appliance including at least one device according to the invention comprises a remote controller 10 for transmitting radio control commands, and a receiver 20 for receiving the radio control commands from the remote controller 10 and controlling the device to operate under the control of the control commands. The at least one device of digital household appliance may be PCs, digital TVs, digital audios and etc. The remote controller 10 and the device equipped with the receiver 20 form a digital household network, as shown in FIG. 1, through which the device will be wirelessly controlled by using the remote controller 10 and receiver 20. For example, video files and audio files stored in a computer can be displayed on a digital TV and played on a digital audio, respectively, by means of exchanging data through the network under the control of the remote controller 10.

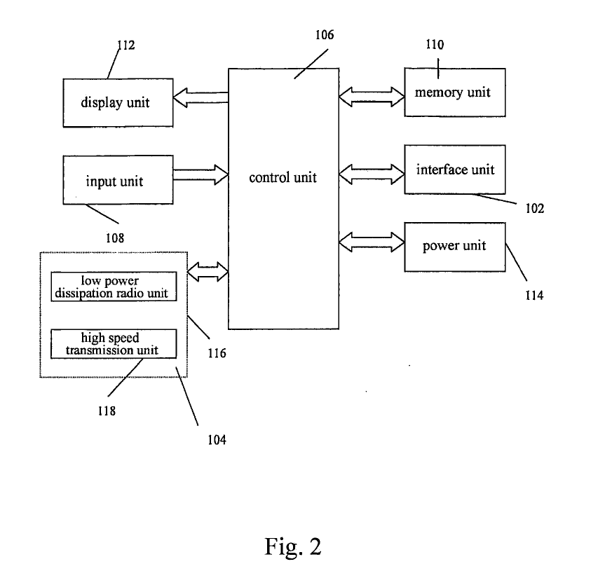

Referring to FIG. 2, the remote controller 10 comprises a control unit 106, a radio unit 104, an interface unit 102, an input unit 108, a display unit 112, memory unit 110 and a power unit 114, wherein all of the radio unit 104, the interface unit 102, the input unit 108, the display unit 112, the memory unit 110 and the power unit 114 are connected to the control unit 106, respectively. The radio unit 104 includes a low power dissipation radio unit 116 and a high speed transmission unit 1168.

The control unit 106 is a kernel part of the remote controller 10 and responsible for processing data and controlling the operation of the system. The control unit 106 includes a controller which can be implemented with an ARM chip having MMU (memory management unit) function, such as ARM 720T, StrongARM, ARM920T, and ARM922T or the like. The control unit 106 operates the operating system of the remote controller 10, wherein the operating system may be a WinCE, a VxWorks, and an embedded Linux.

The memory unit 110 is adapted to store a big volume of data in order to function as a data source used for the digital household appliance. The memory unit 110 may be implemented by hard disks, semiconductor memory media, magnetic memory media and optical memory media, such as Flash Memory FRAM, MRAM, DRAM, SDRAM, EEPOM, SRAM, EPPOM or Millipedes.

The interface unit 102 provides an interface for connecting a memory device, a PC and other host device. The interface may be one of interfaces like CF, SM, MMC, SD, MS, MD, X-D, and PCMCIA. The interface may further include USB, IEEE1394, serial ATA, IDE/SCSI, HiperLAN, Bluetooth, IrDA, HomeRF, IEEE802.11x, IEEE802.11a, IEEE802.11, IEEE802.11d, IEEE802.11.g, IEEE802.15, IEEE802.16, IEEE802.3, RS232, RS485, USB-OTG, UWB, POI and URAT, but also include one or more of GSM, GPRS, CDMA, 2.5G, 3G interfaces and parallel interfaces. Via the interface unit 102, the remote controller 10 is able to read data stored in an external memory device or to download data from a PC and other host device, and store the obtained data into the memory unit 110.

The radio unit 104 includes a low power dissipation radio unit 116 and a high speed transmission unit 118 for executing wireless communication among digital devices having the receiver 20, such as PCs, digital TVs, digital Audios, or the like, within the digital household network. The unit 116 may adopt communication protocols like Bluetooth, Zigbee, IrDA, etc. The unit 118 may adopt one or more wireless communication protocols including but limited to HomeRF, UWB, IEEE802.11x, IEEE802.11a, IEEE802.11b, IEEE802.11d, IEEE802.11g, IEEE802.15, IEEE802.16, IEEE 802.3, GSM, GPRS, CDMA, 2.5G and 3G. The control unit 106 can switch between the low power dissipation radio unit 116 and the high speed transmission unit 118. In a default mode, the low power dissipation radio unit 116 is ON and the high speed transmission unit 118 is OFF. For a purpose of illustration, the low power dissipation radio unit 116 is exemplified by an infrared module, and the high speed transmission unit 118 is exemplified by an IEEE802.11 communication module.

The input unit 108 is connected to an input terminal device, such as a keyboard, a voice-input device, a touch screen or the like, for receiving commands from a user.

The display unit 112 displays an interface of the operating system for the remote controller 10 for users' operation. A displayer like LCD, CRT, VFD, LCM, LED, and OLED, etc. may be connected to the display unit 112.

The power unit 114 supplies a power to the remote controller 10. Batteries like lithium batteries may be used for powering the remote controller 10. Alternatively, AC from an external AC power supply could be converted by an A/D converter (not shown in FIG. 2) to power the remote controller 10, similar with the manner of power supply for PDAs and Notebook PCs.

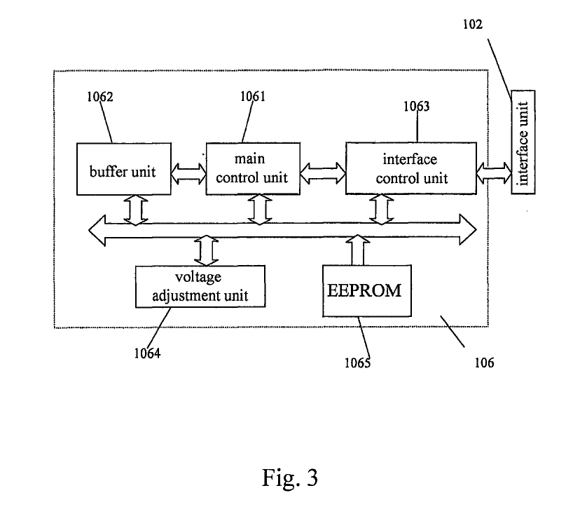

Referring to FIG. 3 now, the control unit 106 of the remote controller 10 comprises a main control unit 1061, a buffer unit 1062, an interface control unit 1063, a voltage adjustment unit 1064 and an EEPROM 1065, all of which are connected to a BUS. The main control unit 1061 is connected to the buffer unit 1062 and the interface control unit 1063, respectively. The interface control unit 1063 is connected to the interface unit 102.

The main control unit 1061 controls the interface unit 102 and carries out exchange of data, commands, addresses, status information among the buffer unit 1062, the EEPROM 1065 and the interface control unit 1063. The main control unit 106 includes programming codes to be run, the operating system of the remote controller 10, and a control information database of the digital household appliance like PCs, digital TVs, digital Audios, etc. The programming codes are extensible according to the actual requirements so as to introduce new functions into the system. The software of the remote controller could be upgraded by means of e.g. obtaining upgraded software from an external device via the interface unit 102.

The buffer unit 1062 is employed to buffer data and may be implemented with a SRAM, a SDRAM, a DDRAM and a RDRAM or the like.

The program instructions and preset information like interface identifying codes and command sets provided by a manufacturer to be run in the main control unit 1061 and the interface control unit 1063 are fixed into the EEPROM 1065.

The voltage adjustment unit 1064 is employed to adjust the voltage of the remote controller 10 so as to satisfy the voltage requirements of various operation modes.

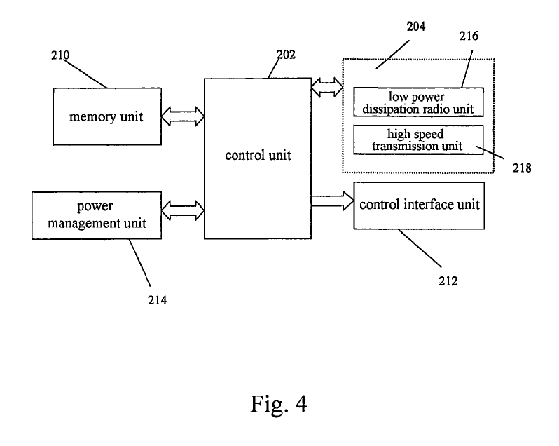

Referring to FIG. 4 now, the receiver 20 includes a control unit 202, a memory unit 210, a power management unit 214, a radio unit 204 and a control interface unit 212. The memory unit 210, the radio unit 204, the power management unit 214 and the control interface unit 212 are connected to the control unit 202.

If the receiver 20 is integrated into the digital household appliance, the power management unit 214 may receive a current from the appliance so as to supply a work voltage to the receiver 20. If the receiver 20 is an independent device from household appliance, the power management unit 214 may have a separate power supply to supply a voltage to the receiver 20.

The control unit 202 is a kernel part of the receiver 20 and responsible for processing data and controlling the operation of the system.

The memory unit 210 is employed to store programming codes and intermediate data to be run on or used by the control unit 202.

The radio unit 204 can conduct wireless communication over any of available wireless networks. Specifically, the radio unit 204 is employed to wirelessly communicate with the radio unit 104 of the remote controller 10. The radio unit 204 further includes a low power dissipation radio unit 216 and a high speed transmission unit 218. The low power dissipation radio unit 216 communicates with the low power dissipation radio unit 116 of the remote controller 10 by a way of low power dissipation communications according to wireless communication protocols including but limited to Bluetooth, Zigbee, and IrDA. The high speed transmission unit 218 communicates with the high speed transmission unit 118 of the remote controller 10 by a way of high speed wireless communication according to wireless communication protocols including but not limited to one or more of HomeRF, UWB, IEEE802.11x, IEEE802.11a, IEEE802.11b, IEEE802.11d, IEEE802.11g, IEEE 802.15, IEEE 802.16, IEEE 802.3, GSM, GPRS, CDMA, 2.5G and 3G.

The control interface unit 212 is employed to change the control commands received by the receiver 20 from the remote controller 10 into control signals which are identified by the devices for operation.

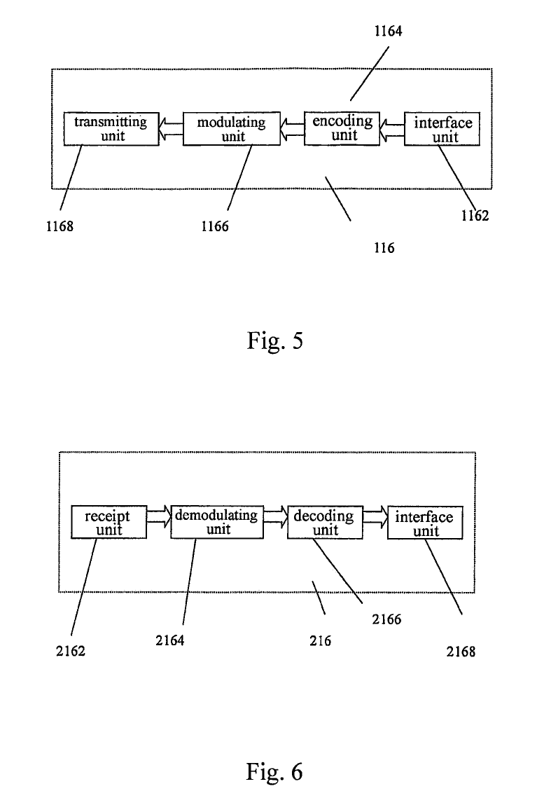

Referring now to FIG. 5, the low power dissipation radio unit 116 of the remote controller 10 according to the embodiment includes an interface unit 1162, an encoding unit 1164, a modulating unit 1166 and a transmitting unit 1168. The interface unit 1162 receives binary control commands from the control unit 106 and inputs the received binary control commands to the encoding unit 1164. The encoding unit 1164 encodes the received binary control commands and transmits encoded pulse signals to the modulating unit 1166. The modulating unit 1166 receives and modulates the pulse signals, and transmits the modulated pulse signals to the transmitting unit 1168 in which one or more infrared LEDs are enabled to change the modulated pulse signals into infrared signals for transmission.

Referring now to FIG. 6, the low power dissipation radio unit 216 of the remote controller 10 according to the embodiment includes a receiving unit 2162, a demodulating unit 2164, a decoding unit 2166 and an interface unit 2168. The receiving unit 2162 receives infrared signals from the remote controller 10, changes the received infrared signal into electric signals, and transmits the electric signals to the demodulating unit 2164. The demodulating unit 2164 receives the electric signals, demodulates the received electric signals into a coded pulse signals, and transmits the coded pulse signal to the decoding unit 2166 which in turn decodes the coded pulse signals into binary digital signals and transmits the same to the interface unit 2168. The interface unit 2168 transmits the binary digital signals to the control unit 202.

When the high speed transmission unit 118 of the remote controller 10 and the high speed transmission unit 218 of the receiver 20 are ON, the remote controller 10 and various household devices having the receiver 20 form a wireless digital household network by virtue of one or more wireless communication protocols such as IEEE802.11 protocol, UWB protocol, GSM protocol, GPRS protocol, CDMA protocol, 2.5G protocol or 3G protocol. The devices may be PCs, digital TVs, digital Audios, etc. For a purpose of illustration, the digital household network formed by the remote controller 10 and the devices follows e.g. IEEE802.11 communication protocol. The IEEE802.11 communication protocol specifies two wireless local network operating modes, namely, Ad-doc mode and Infrastructure mode.

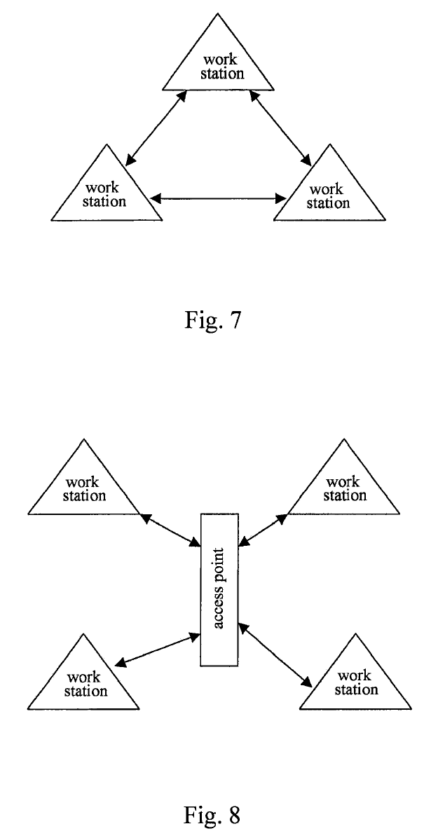

Referring to FIG. 7, which is a schematic diagram for showing a wireless local network in an Ad-doc mode. Each of work stations within the network can communicate with each other equally. In the embodiment, the remote controller 10 is set as an initial work station to initialize the wireless local network. Meanwhile, the remote controller 10 and the devices including e.g. PCs, digital TVs, digital Audios, etc. form a digital household network. The remote controller 10 equally communicates with each of devices of the network, respectively. The remote controller 10 operates as a control center to control these devices of the network.

Referring to FIG. 8, which is a schematic diagram for showing the configuration of a wireless local network in an Infrastructure mode. In this case, the remote controller 10 operates as an access point (AP), and devices of the network such as PCs, digital TVs, digital Audios, etc. operate as work stations. The remote controller 10 and these devices constitute a digital household network with a star-shaped topology, as shown in FIG. 6.

In the Infrastructure mode, PCs, digital TVs, digital Audios, etc. cannot communicate with each other directly. Instead, communication signals among devices are relayed by the AP, i.e. the remote controller. The remote controller 10 manages the communications among various devices of the network. To this end, a MAC frame should comprise a source address, a destination address and an access point address. The access point address is the MAC address of the remote controller 10. A bridge connection table is established in the remote controller 10. When a device (source station) in the network intends to communicate with another one (destination station), a data frame is firstly transmitted to the remote controller 10. The remote controller 10 receives the data frame, retrieves the MAC address of the destination station from the data frame, and transmits the retrieved MAC address by conducting a search in the bridge connection table.

In the digital household network, the remote controller 10 provides not only a bridge connection among the devices of the network, but also a connection to a cable local network. The digital household network can also be connected to an Internet so that a PC may access a local network or Internet, or request some services like network printing, etc. In addition, resources of the Internet may be browsed on a digital TV.

Due to formation of the digital household network, devices of the network can communicate each other, without needing additional means except for the remote controller 10. Information on each device within the network can be retrieved by the remote controller 10. Therefore, within the coverage of the remote controller 10, all devices can work effectively, which could save a lot of resource, expand the network by adding new devices, and increase the working distance of the remote controller.

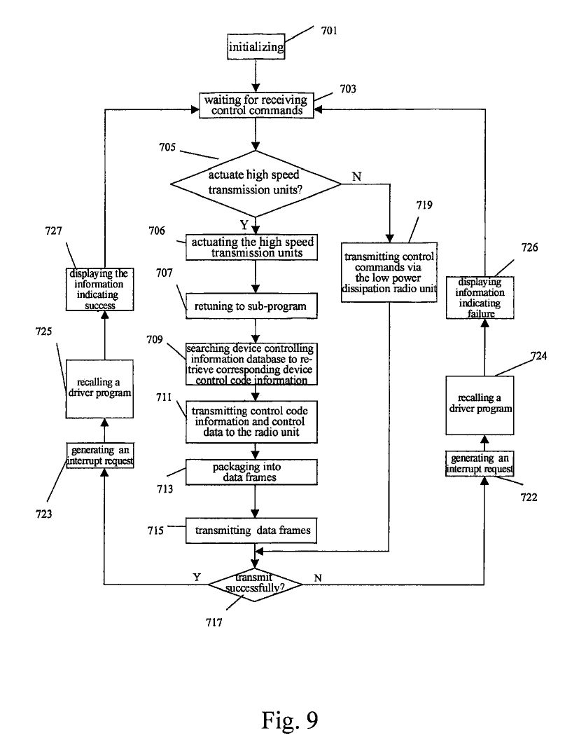

Please refer to FIG. 9. When the remote controller 10 is powered up, the control unit 106 is initialized and the operating system is loaded at step 701. A user interface of the operating system will be displayed on a display terminate connected to the display unit 112.

Step 703 is to await control commands which are input by users through an input means connected to the input unit 108. First, a user may select by means of the input means an icon representing one device f to be controlled. The control unit 106 displays all operations regarding the selected device on the user interface. The user may utilize the input means to select one of the operations. The input unit 108 sends an interrupt request to the operating system based on the selected operation.

The process goes to step 705 after the operating system receives the interrupt request. At step 705, the operating system determines whether or not to actuate the high speed transmission unit 118 of the remote controller 10 and the high speed transmission unit 218 of the receiver 20 based on the user's selection.

Whether to actuate the high speed transmission unit 118 of the remote controller 10 and the high speed transmission unit 218 of the receiver 20 depends on characteristics of data to be transmitted by the radio unit 104. If there is not a big number of data to be transmitted for some operations such as operation for adjusting channels, volume and picture color of a TV, there is no need to actuate the high speed transmission unit 118 and the high speed transmission unit 218.

If the high speed transmission unit 118 and the high speed transmission unit 218 are not actuated, the process goes to step 719 in which the control unit 106 controls the low power dissipation radio unit 116 to transmit corresponding control commands to carry out selected operations. In detail, the interface unit 1162 of the low power dissipation radio unit 116 receives binary control commands from the control unit 106, and then inputs the received binary control commands to the encoding unit 1164. The encoding unit 1164 encodes the received binary control commands, and then transmits an encoded pulse signals to the modulating unit 1166. The modulating unit 1166 receives and modulates the pulse signals and then transmits the modulated signals to the transmitting unit 1168. The transmitting unit 1168 receives the modulated signals and actuates one or more infrared LEDs so as to change the modulated signals into infrared signals, and transmits the infrared signals. The process then goes to step 717 to determine whether data frames are transmitted successfully.

If the radio unit is actuated, the process goes to step 706. At step 706, the remote controller 10 actuates the high speed transmission unit 118, and transmits an actuation command to the receiver 20 by means of the low power dissipation radio unit 116 to actuate the high speed transmission unit 218.

The process goes to step 707 to start a sub-process.

At step 709, the sub-process accesses a device control information database to retrieve the corresponding device control code information.

At step 711, the control code information is processed by the control unit 106, and then transmitted to the radio unit 104.

At step 713, the high speed transmission unit 118 packets the control code information as data frames.

At step 715, the data frames are transmitted to the high speed transmission unit 218 of the corresponding receiver 20 via a physic layer interface of the high speed transmission unit 118.

At step 717, it is determined whether the data frames are transmitted successfully.

If it is successful, the sub-process then returns to step 723. At step 723, the radio unit 104 sends an interrupt request to the control unit 106 to execute an interruption.

At step 725, the operating system, according to addresses of an interruption program set by a driver program of the radio unit 104, recalls the driver program to execute corresponding interruption.

Then, at step 727, the operating system displays, on the user interface, information for indicating the success of the operation. The process then returns to step 703 for awaiting control commands. In this case, the user interface returns to a status for awaiting control commands.

If the transmission is not successful (at step 717) the radio unit 104 sends an interrupt request to the control unit 106 at step 722.

At step 724, the operating system, according to addresses of an interrupt program set by a driver program of the radio unit 104, recalls the driver program to execute corresponding interruption.

At step 726, the operating system displays, on the user interface, information for indicating the failure of the operation. The process then returns to step 703 to wait for control commands, and the user interface returns to a status of awaiting control commands.

Hereafter is to illustrate the work process of the receiver 20.

If the remote controller 10 transmits control commands at step 719 (namely, the transmission is done through the low power dissipation radio unit 116 in this embodiment), the receiver 20 receives the control commands by virtue of the low power dissipation radio unit 216. Specifically, the receiving unit 2162 receives the infrared signals from the low power dissipation radio unit 116 of the remote controller 10, and changes the received infrared signals into electric signals which are in turn transmitted to the demodulating unit 2164. The demodulating unit 2164 receives and demodulates the received electric signals into coded pulse signals, and transmits the coded pulse signals to the decoding unit 2166. The decoding unit 2166 decodes the coded pulse signals into binary digital signals which are in turn transmitted to the interface unit 2168. The interface unit 2168 transmits the binary digital signals to the control unit 202 for further use. The control unit 202 controls the digital household appliance to operate as per the control commands.

If the remote controller 10 transmits control commands by the low power dissipation radio unit 116 to control the receiver 20 to actuate the high speed transmission unit 218, the high speed transmission unit 118 is also actuated to transmit the data frames. In this case, the receiver 20 operates as following.

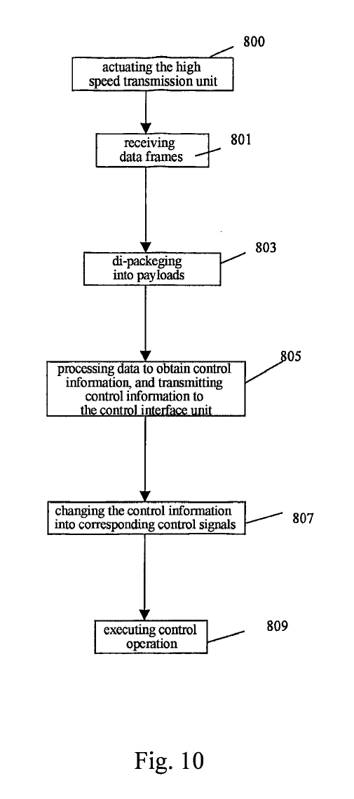

Please refer to FIG. 10. After the digital household appliance with the receiver 20 receives control commands transmitted from the remote controller 10, the process starts at step 800.

At step 800, the low power dissipation radio unit 216 receives actuation commands from the low power dissipation radio unit 116 of the remote controller 10, and then transmits received actuation commands to the control unit 202 which in turn actuates the high speed transmission unit 218.

Then, at step 801, the high speed transmission unit 218 receives data frames transmitted by the high speed transmission unit 118 of the remote controller 10.

At step 803, the high speed transmission unit 218 di-packets the received data frames, and transmits payloads derived from the non-packeted data frames to the control unit 202 for further use.

At step 805, the control unit 202 processes the received payloads to obtain control information, and transmits the obtained control information to the control interface unit 212.

Then, at step 807, the control unit 202 changes the control information so as to be identified by the digital household appliance.

At last, the control unit 202 controls the digital household appliance to operate as per the corresponding control information at step 809.

The remote controller 10 and the receiver 20 carry out above processes to control all the functions of the digital household appliance in the digital household network. For example, the remote controller 10 controls digital TVs to switch channels, adjust volume and so on, the remote controller 10 provides a data resource for the digital household appliance so that picture or text filed stored in the user memory unit 110 may be showed on digital TVs, or data from a PC may be stored into the memory unit 110 or a memory device connected to the interface unit 102.

How the remote controller controls digital TVs to switch channels and adjust volume is well known for those skilled in the art, and will not be described in detail herein. A process for exchanging data between the remote controller 10 and the digital household appliance is now described. This embodiment is to show a process for displaying data stored in the memory unit 110 on a digital TV, and a process for storing data wirelessly received from a PC into the memory unit 110.

The following illustration relates to such a process that the remote controller 10 reads the data which are stored in a memory device connected to the interface unit 102, and stores the read data into the memory unit 110.

When an external memory device is connected to the interface unit 102, the interface control unit 1063 detects and identifies the communication protocol to which the memory device follows and electric characteristics of the memory device. If the identification fails, the interface control unit 1063 sends an interrupt request to the main control unit 1061 which in turn informs the control unit 106 of the failure of the connection. The control unit 106 displays corresponding error information on the user interface of the display unit 112. If the identification is successful, the main control unit 1061 sends control commands to the voltage adjustment unit 1064 which in turn supplies an operating voltage to the memory device. Once the memory device is powered up, the memory device is in a read-only state.

Meanwhile, the user may utilize the input terminal device connected to the input unit 108 to operate the remote controller 10 so as to select commands for displaying contents of the memory device. The control unit 106 of the remote controller 10 translates the selected commands into specific control signals, which are in turn transmitted to the main control unit 1061 of the control unit 106. The main control unit 1061, upon the received control signal, transmits control commands to the interface control unit 1063. The data stored in the memory unit is then read and transmitted to the main control unit 1061 by the interface control unit 1063. The main control unit 1061 stores the data into the memory unit 110 and requests the operating system carrying out an interrupt process. The operating system then carries out an interrupt program to translate the data into user-identifiable document information which is then displayed on the user interface of the display terminal device.

Hereinafter, a process for displaying the data stored in the memory unit 110 or a memory device connected to the interface unit 102 on digital TVs will be discussed.

The user utilizes the input terminal device of the remote controller 10 to select the data stored in the memory unit 110 to be displayed. The display unit 112 of the remote controller 10 displays the user-identifiable document information stored in the memory unit 110 by means of the user interface of the operating system. The user may also utilize the input terminal device of the remote controller 10 to select documents to be transmitted to and displayed on a digital TV, and select an icon of digital TV which will display the documents.

Upon the above selection, the operating system determines whether to actuate the high speed transmission unit 118 of the remote controller 10 and the high speed transmission unit 218 of the receiver 20 to carry out the selected operations. If it is the case, the high speed transmission unit 118 is actuated and actuation commands for actuating the high speed transmission unit 218 are transmitted to the receiver 20 by the low power dissipation radio unit 116. The operating system accesses the device control information database to obtain control code information for the digital TV to be controlled. The control code information is processed by the control unit 106, and then transmitted to the high speed transmission unit 118 which in turn packets the control code information into data frames. The data frames are then transmitted to the high speed transmission unit 218 of the receiver 20 of the digital TV via the physical interface layer of the high speed transmission unit 118. The high speed transmission unit 218 dipackets the received data frames, and transmits payloads derived from the dipacketed data frames to the control unit 202. The control unit 202 processes the received payloads to achieve control information which in turn is transmitted to the control interface unit 212. The control unit 212 changes the control information to control signals to be identified by the digital household appliance so as to enable the digital TV to receive the data transmitted from the remote controller 10.

Subsequently, the data stored in the memory unit 110 or the memory device connected to the interface unit 102 is read by the control unit 116 of the remote controller 10. Data frames are then wirelessly transmitted to the high speed transmission unit 218 of the receiver 20 of the digital TV from the high speed transmission unit 118 of the remote controller 10. The high speed transmission unit 218 dipackets the received data frames and transmits payloads derived from the dipacketed data frames to the control unit 202. The control unit 202 further processes the received payloads to buffer the data information contained in the payloads into the memory unit 210. The buffered data information is then displayed on the screen of the digital TV.

The data information may also be wirelessly transmitted and then displayed on an analog TV by the remote controller 10 via a top-set box, the processes of which are similar to those used for displaying contents stored in the memory unit 110 on the digital TV, and will not be described in detail herein.

Hereinafter, the processes for wirelessly obtaining data from a PC and storing the obtained data into the memory unit 110 or the memory device connected to the interface unit 102 will be discussed.

The user utilizes the input terminal device of the remote controller 10 to select an icon for a PC on the user interface of the operating system. The user interface then displays all icons for documents which are read from the PC. After the user utilizes the input terminal device to select a document icon (that is used to select and store corresponding document into the memory unit 110) to select commands for obtaining the corresponding document from the PC and storing the corresponding document into the memory unit 110 or the memory device connected to the interface unit 102, the operating system actuates the high speed transmission unit 118 of the remote controller 10, and then transmits an actuation command to control the receiver 10 via the low power dissipation radio unit 116 so that the high speed transmission unit 218 is actuated. The operating system of the remote controller 10 then accesses the device controlling information database to obtain corresponding control code information. The control code information is processed by the control unit 106, and then transmitted to the radio unit 104 which in turn packets the control code information into data frames. The data frames are then transmitted to the radio unit 204 of the receiver 20 of the PC via a physical interface layer. The radio unit 204 un-packets the received data frames, and transmits payloads derived from the dipacketed data frames to the control unit 202 of the receiver 20 to make further use. The controlling information contained in the payloads is obtained and processed by the control unit 202 so that the data of the selected document is processed and transmitted to the high speed transmission unit 218 which in turn packets the data into data frames for transmission. The high speed transmission unit 118 of the remote controller 10 receives and un-packets the data frames to transmit payloads contained therein to the main control unit 106 to make further process so that the main control unit 106 stores the document into the memory unit 110 or the memory device connected to the interface unit 102.

In addition, the remote controller 10 may also be used to control a printer to print documents stored in the memory unit 110 of the remote controller 10 or stored in the memory device connected to the interface unit 102. To this end, it is necessary for the printer to have a radio unit to act as a wireless network server so that the printer may work as a wireless network printer. The specific printing processes is similar to those used for displaying a document on the digital TV, and will not be described in detail herein.

While prefer embodiments has been described above, it is understand for those skilled in the art that various modifications and improvements may be made thereto without departing from the sprit and scope of the invention.

1. A remote controller for controlling digital household appliance including at least one device, including a power unit and an input unit, the remote controller further comprising:
a radio unit for operating at least two wireless communication modes;
a control unit for selecting one of the at least two wireless communication modes; and
wherein the control unit selects one wireless communication mode from the at least two wireless communication modes according to control commands inputted by a user and transmits the control commands to the device for controlling operations of the device.

2. A remote controller according to claim 1, wherein the radio unit comprises a low power dissipation radio unit and a high speed transmission unit.

3. A remote controller according to claim 2, wherein the low power dissipation radio unit adopts one of wireless commutation protocols including but not limited to Bluetooth protocol, Zigbee protocol and IrDA infrared protocol.

4. A remote controller according to claim 2, wherein the high speed transmission unit adopts one of wireless communication protocols including but not limited to HomeRF protocol, UWB protocol, IEEE802.11x protocol, IEEE802.11a protocol, IEEE802.11b protocol, IEEE802.11d protocol, IEEE802.11.g protocol, IEEE802.15 protocol, IEEE802.16 protocol, IEEE802.3 protocol, GSM protocol, GPRS protocol, CDMA protocol, 2.5G protocol and 3G protocol.

5. A remote controller according to claim 2, wherein the operation of the low power dissipation radio unit is preset as a default mode.

6. A remote controller according to claim 1, wherein the control unit selects one corresponding communication mode from the at least two wireless communication modes according to the control commands inputted by the user and/or characteristics of data transmitted by the radio unit.

7. A wireless control system for digital household appliance including at least one device, comprising:
a remote controller for wirelessly transmitting control commands, the remote controller being able to operate at least two wireless communication modes;
a receiver for receiving and executing the control commands transmitted by the remote controller, and
wherein the remote controller selects one wireless communication mode from the at least two wireless communication modes according to the control commands to wirelessly communicate with said device or said receiver.

8. The system according to claim 7, wherein the remote controller implements said at least two wireless communication modes by providing and operating a low power dissipation radio unit and a high speed transmission unit.

9. The system according to claim 8, wherein the low power dissipation radio unit and the high speed transmission unit are switchable under the control of a control unit.

10. The system according to claim 8, wherein the low power dissipation radio unit adopts one of wireless commutation protocols including but not limited to Bluetooth protocol, Zigbee protocol and IrDA infrared protocol.
